(19) United States
(12) Patent Application Publication
(10) Pub. No.: US 2009/0168677 A1
(43) Pub. Date: Jul. 2, 2009

(54) Method of Minimizing Electric Power Consumption In Wireless Sensor Network

(75) Inventors: Tae-Joon Kang, Gwangmyung-Si (KR); Chan-Hee Jun, Jungrang-Gu (KR)

Correspondence Address: ARENT FOX LLP, 1050 CONNECTICUT AVENUE, N.W., SUITE 400, WASHINGTON, DC, 20036, US

(73) Assignees: D&S Technology Co., Ltd., Guro-Gu (KR); TaoNetworks Inc., Guro-Gu (KR)

(21) Appl. No.: 12/026,222

(22) Filed: Feb. 5, 2008

(30) Foreign Application Priority Data
Dec. 27, 2007 (KR) 0138959 / 2007

(51) Int. Cl. G08C 17/02

(52) U.S. Cl. 370/311

(57) ABSTRACT

Disclosed herein is a method of minimizing electric power consumption in a wireless sensor network. In a large-scale transmission power control process, a sender node determines whether a transmission power value for a receiver node is determined. If the transmission power value is not determined, the sender node transmits data to the receiver node at maximum power. The receiver node calculates an RSSI value, writes the RSSI value in an ACK signal, and transmits the ACK signal to the sender node. Thereafter, the sender node calculates an approximate transmission power value. In a small-scale transmission power control process, if new data is generated, the sender node transmits the data to the receiver node at newly determined transmission power. The receiver node calculates an RSSI value, writes the RSSI value in an ACK signal, and transmits the ACK signal to the sender node. The sender node adjusts a transmission power level.

### BACKGROUND OF THE INVENTION

1. Field of the Invention

The present invention relates generally to a method of constituting an efficient and stable wireless sensor network using a small amount of electric power, and, more particularly, to a method of minimizing electric power consumption in a wireless sensor network, in which a sender node which constitutes the network transmits data to a receiver node using a minimum amount of electric power, so that the electric power consumed when the sender node transmits data is minimized.

2. Description of the Related Art

Each node of conventional wireless sensor network is operated by a small-capacity battery, so that it is important to stably transmit data using an extremely small amount of energy when data is transmitted or received.

Conventionally, a method of reducing the amount of energy consumed during transmission by properly adjusting the size of electric power when data is transmitted through a radio chip is used as a transmission power control method.

FIG. 1 is a view showing the range of the transmission of data transmitted from a sender node at a conventional wireless sensor network.

Referring to FIG. 1, in a conventional wireless sensor network, if a sender node transmits data using a CC2420 radio chip at the maximum transmission power (0 dBm), a current of 17.4 mA is consumed. An available distance, in which data can be transmitted at a transmission power 0 dBm, ranges from 70 m to 100 m. If the location of a receiver node is closer than the available distance, setting was made such that the available distance is unnecessarily large. Therefore, if transmission power is properly adjusted, the amount of energy which is generated during data transmission can be reduced.

In FIG. 1, if the location of the receiver node is considered, data can be sufficiently transmitted to a destination even when data is transmitted at a transmission power −15 dBm. Here, current consumption can be reduced to 9.9 mA.

That is, in order to reduce transmission energy through transmission power control, a minimum transmission power value capable of providing the almost 100% transmission rate must be detected.

### SUMMARY OF THE INVENTION

Accordingly, the present invention has been made keeping in mind the above problems occurring in the conventional, and an object of the present invention is to provide a method of constituting an efficient and stable wireless sensor network using a small amount of electric power, and, more particularly, to provide a method of minimizing electric power consumption in a wireless sensor network, in which a sender node which constitutes the network transmits data to a receiver node using a minimum amount of electric power, so that the electric power consumed when the sender node transmits data is minimized.

In order to accomplish the above-described object, the present invention provides a method of minimizing electric power consumption in a wireless sensor network, the method including a Large-scale Transmission Power Control (L-TPC) process; and a Small-scale Transmission Power Control (S-TPC) process, wherein the L-TPC process includes a first step of a sender node determining whether a transmission power value for a receiver node is determined before the sender node transmits data to the receiver node; a second step of the sender node, if the transmission power value is not determined, transmitting data to the receiver node at maximum power; a third step of the receiver node which received the data calculating a Radio Signal Strength Indicator (RSSI) value, writing the RSSI value in an ACK signal, and then transmitting the ACK signal to the sender node; and a fourth step of the sender node which received the ACK signal calculating an approximate transmission power value based on the RSSI value written in the ACK signal; and wherein the S-TPC process includes a first step of the sender node, if new data is generated later, transmitting the data to the receiver node at newly determined transmission power; a second step of the receiver node which received data at the newly determined transmission power calculating an RSSI value, writing the RSSI value in an ACK signal, and transmitting the ACK signal to the sender node; and a third step of the sender node adjusting a transmission power level based on the received RSSI value.

### BREIF DESCRIPTION OF THE DRAWINGS

The above and other objects, features and other advantages of the present invention will be more clearly understood from the following detailed description taken in conjunction with the accompanying drawings, in which:

FIG. 1 is a view showing the range of the transmission of data transmitted from a sender node at a conventional wireless sensor network;

FIGS. 2A and 2B are views showing the basic concept of an ODTPC algorithm according to the present invention;

FIG. 3 is a view showing a process of a sender node determining proper transmission power value using the ODTPC algorithm according to the present invention;

FIG. 4 is a graph showing a principle of the sender node calculating a distance between the sender node and a receiver node using the value of an RSSI written in an ACK signal according to the present invention; and

FIG. 5 is a graph showing a guard region in which transmission power level should be adjusted according to the present invention.

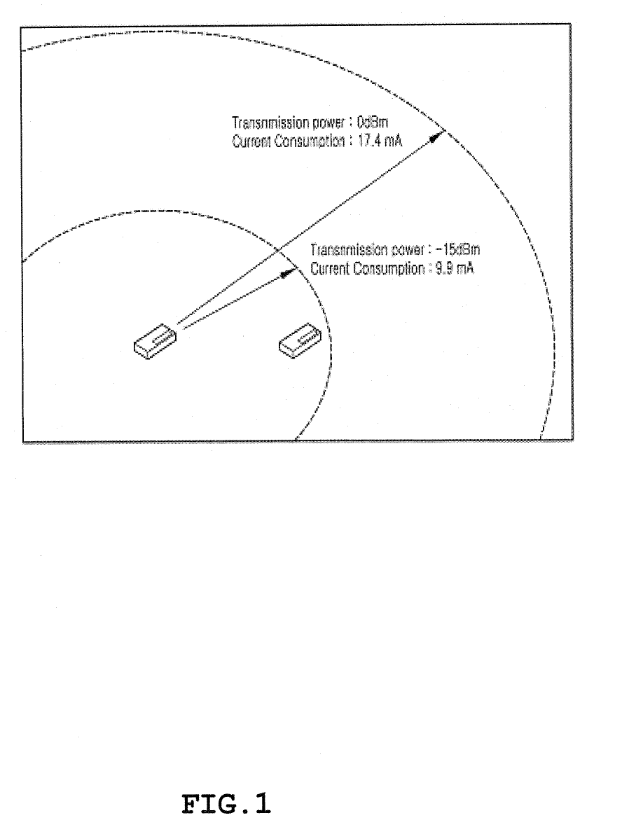

### DESCRIPTION OF THE PREFERRED EMBODIMENTS

In order to sufficiently understand advantages of the present invention and the operation of the present invention and objects accomplished through the embodiments of the present invention, the accompanying drawings which illustrate the preferred embodiments of the present invention and details described in the accompanying drawings should be referred to.

Hereinafter, the present invention will be described in detail by describing preferred embodiments of the present invention with reference to the attached drawings. The same reference numerals, which are used throughout the different drawings, designate the same or similar components.

The present invention provides a method of minimizing electric power, consumed when data is transmitted from a sender node to a receiver node, using an On-demand Transmission Power Control (ODTPC) algorithm.

The ODTPC algorithm is an On-demand method, that is, a method of determining proper transmission power when data transmission is actually requested without transmitting/receiving data several times by each node in order to determine transmission power beforehand. Therefore, energy consumption, which is generated during the initialization process of the conventional algorithm, can be reduced.

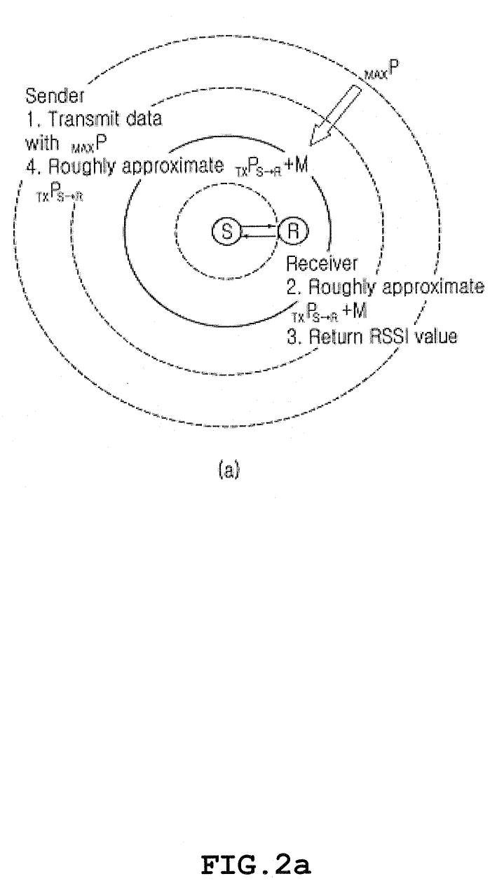

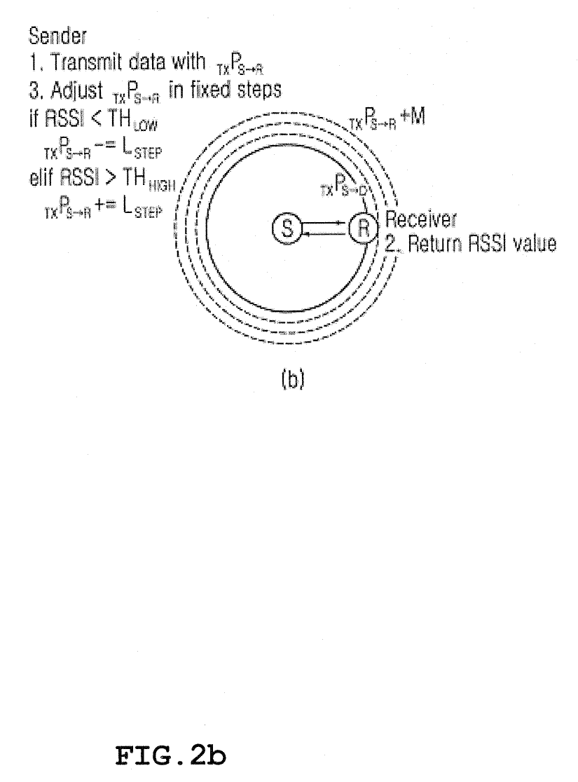

FIGS. 2A and 2B are views showing the basic concept of ODTPC algorithm according to the present invention;

Referring to FIGS. 2A and 2B, the ODTPC algorithm can be largely divided into a Large-scale Transmission Power Control (L-TPC) process shown in FIG. 2A and a Small-scale Transmission Power Control (S-TPC) process shown in FIG. 2B.

Basically, the ODTPC algorithm is used to determine proper transmission power using a Radio Signal Strength Indicator (RSSI). However, from the viewpoint of the characteristics of wireless channels, it is difficult to detect the proper transmission power using the RSSI.

Therefore, in the L-TPC process, approximate transmission power is calculated based on the RSSI, and then a transmission power level is adjusted by increasing or decreasing it by one level in the S-TPC process.

The S-TPC process uses a method similar to the inner-loop transmission power control algorithm of a closed-loop transmission power control algorithm which is a standard transmission power control algorithm of a Code Division Multiple Access (CDMA) method.

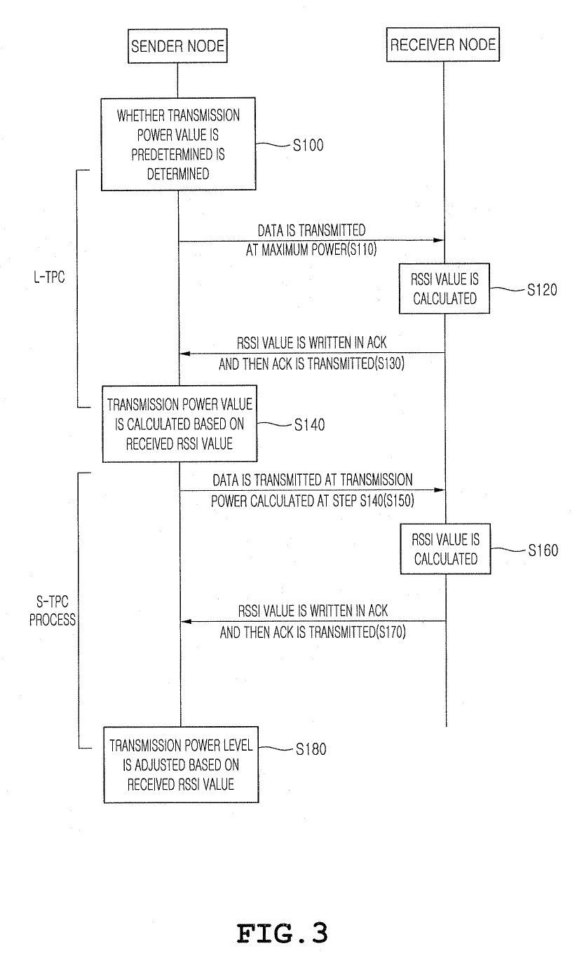

FIG. 3 is a view showing a process of a sender node determining proper transmission power value using the ODTPC algorithm according to the present invention.

Referring to FIG. 3, the ODTPC algorithm according to the present invention can be divided into the L-TPC process and the S-TPC process.

First, the L-TPC process will be described. The sender node determines whether a transmission power value for the receiver node is predetermined before the sender node transmits data to the receiver node at step S100.

If the transmission power value is not predetermined, the sender node transmits data to the receiver node at the maximum power at step S110.

The receiver node, which received the data, obtains a RSSI value at step S120, writes the RSSI value in an ACK signal, and then transmits the ACK signal to the sender node at step S130.

The sender node, which received the ACK signal, calculates approximate transmission power value based on the RSSI value written in the ACK signal at step S140.

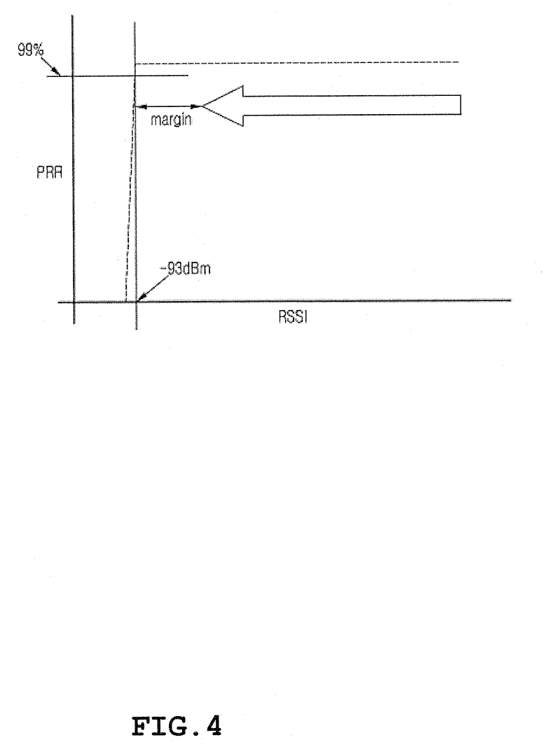

Referring to FIG. 4, the sender node can calculate the distance between the sender node and the receiver node using the RSSI value written in the ACK signal, as illustrated in Equation 1.

$$d = 8 \times 10 \frac{{P}_{t} - {P}_{r} - 58.5}{33} \qquad Equation 1$$

Where, d is 8 m or greater, and a transmission power value Pt which satisfies an RSSI threshold value (−93 dBm) can be obtained using a log-normal shadowing path loss model, as illustrated in Equation 2. In consideration of the other factors, a margin value M can be added to the transmission power value Pt so as to secure stability.

$${P}_{t} ( dB ) = {RSSI}_{THRESHOLD} ( dB ) + 58.5 + 33 log \frac{d ( m )}{8} + M \qquad Equation 2$$

Next, the S-TPC process will be described. If new data is generated later, the sender node transmits data to the receiver node at the transmission power, determined at step S140, at step S150.

The receiver node which received data at the transmission power, determined at step S140, calculates an RSSI value at step S160, writes the RSSI value in an ACK signal, and then transmits the ACK signal to the sender node at step S170.

If the RSSI value, transmitted at step S170, is greater than a reference value (that is, power is lower than reference), the transmission power level is increased by 1. If the RSSI value is less than the reference value (that is, power is higher than the reference), the transmission power level is decreased by 1 at step S180.

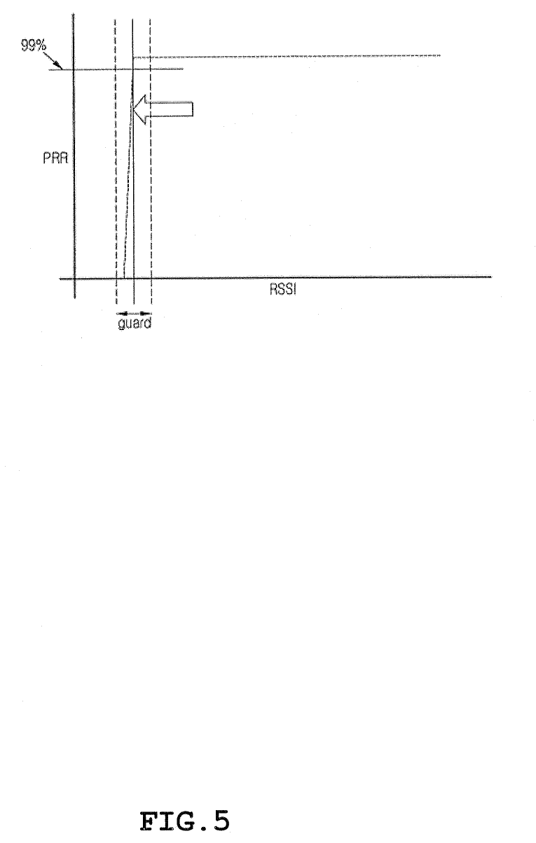

That is, a mathematical method is used one time in the early stage, and than the transmission power level is increased or decreased by 1, so that reception power is placed in a guard region, as shown in FIG. 5.

The size of the guard region is determined based on the sensitivity of the receiver node of a radio chip.

As described above, the present invention provides a method of constituting an efficient and stable wireless sensor network using a small amount of electric power, and, more particularly, to provide a method of minimizing electric power consumption in a wireless sensor network, in which a sender node which constitutes the network transmits data to a receiver node using a minimum amount of electric power, so that the electric power consumed when the sender node transmits data is minimized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of minimizing electric power consumption in a wireless sensor network, the method comprising:
a Large-scale Transmission Power Control (L-TPC) process; and
a Small-scale Transmission Power Control (S-TPC) process wherein the L-TPC process comprises:
a first step of a sender node determining whether a transmission power value for a receiver node is determined before the sender node transmits data to the receiver node;
a second step of the sender node, if the transmission power value is not determined, transmitting data to the receiver node at maximum power;
a third step of the receiver node which received the data calculating a Radio Signal Strength Indicator (RSSI) value, writing the RSSI value in an ACK signal, and then transmitting the ACK signal to the sender node; and
a fourth step of the sender node which received the ACK signal calculating an approximate transmission power value based on the RSSI value written in the ACK signal; and
wherein the S-TPC process comprises:
a first step of the sender node, if new data is generated later, transmitting the data to the receiver node at newly determined transmission power;
a second step of the receiver node which received data at the newly determined transmission power calculating an RSSI value, writing the RSSI value in an ACK signal, and transmitting the ACK signal to the sender node; and
a third step of the sender node adjusting a transmission power level based on the received RSSI value.
